(19) United States
(12) Patent Application Publication
(10) Pub. No.: US 2016/0369472 A1
(43) Pub. Date: Dec. 22, 2016

(54) HIGH FACE-AREA, LOW VOLUME CONCRETE WALL BLOCK AND FORM

(71) Applicant: STONETERRA, INC., VANCOUVER, WA (US)

(72) Inventors: GARRICK J. IANELLO, VANCOUVER, WA (US); PETER BLUNDELL, VANCOUVER, WA (US)

(21) Appl. No.: 15/179,082

(22) Filed: Jun. 10, 2016

Related U.S. Application Data
(60) Provisional application No. 62/182,923, filed on Jun. 22, 2015.

(51) Int. Cl. E02D 29/02; B28B 7/20

(52) U.S. Cl. CPC E02D 29/0266; B28B 7/20

(57) ABSTRACT

A concrete retaining wall block including a void configured to receive a portion of stabilizing material. The surface of the void configured to have a reduced friction where contacting the stabilizing material. The reduced friction reducing the abrasion between the concrete retaining wall block and the stabilizing material.

### RELATED APPLICATIONS

This application claims the benefits of U.S. Provisional Application No. 62/182,923, filed Jun. 22, 2015, herein incorporated by reference in its entirety.

This application is related to commonly owned U.S. patent application No. 7,553,109, issued Jun. 30, 2009 and U.S. patent application No. 7,794,180, issued Sep. 14, 2010, the contents of which are herein incorporated by reference in their entirety.

### BACKGROUND

Retaining walls, large and small, are often constructed from concrete bricks or pavers. To minimize their cost and size, the walls are often a single layer of materials wide and can be many feet tall. The narrow width and tall height, combined with the pressure of the retained earth, makes for an unstable structure. To stabilize the structure and anchor it firmly in place, stabilizing material can be affixed to the blocks and extended into the retained material. The retained material exerts friction on the stabilizing material, locking it within the retained material and thus anchoring the retaining wall blocks, maintaining the integrity of the wall.

Geogrid material is one of the more commonly used stabilizing materials for mechanically stabilized earth structures. Typically, the geogrid is restrained to a block using a mechanical or friction fastener. A friction fastener can include placing the geogrid between two stacked blocks, the weight of the blocks above the geogrid creating the friction that retains the geogrid between the blocks. Another friction fastener can include wrapping the geogrid material around a retaining rod, another retaining rod is placed on atop the first rod and the pair of rods are placed in a groove within the block. An upper block holds the rods in place while the frictional interface between the rods and geogrid material restrains the movement, anchoring the block in place.

One of the critical points in the retaining system is the engagement of the retaining wall element or block with a stabilizing material, such as a geogrid fabric or material. This interface generates large amounts of stress on the stabilizing material which can lead to failure of the stabilizing material or the engagement means used to restrain the material to the block. This failure can be caused in numerous ways, including failure of the fastener, the disengagement of the stabilizing material from the wall and failure of the stabilizing material. The stabilizing material can fail by abrasion of the material against the block. Due to the high force loads on the block and stabilizing material, minimal movement can cause large amounts of abrasion damage to the stabilizing material. Once the stabilizing material fails or disengages from the block, the block is no longer anchored or restrained. The unrestrained block weakens the retaining system and can cause failure of the entire retaining wall.

One of the possible sources of stabilizing material abrasion can be the flashing created when casting concrete to form the block. The flashing is a raised portion of the concrete created at seams in the block form. As the stabilizing material rubs across the flashing, the material can be abraded, potentially weakening the material and leading to its failure. Another potential source of abrasion is the general rubbing of the stabilizing material against the generally rough surface of the block. The inherent abrasive nature of the concrete material used to form the block can be the potential cause of failure of the stabilizing material.

The retaining wall industry would benefit from a block that minimizes the sources of abrasion that can cause stabilizing material failure while maintaining or increasing the engagement of the stabilizing material with the block to further strengthen the system and limit the failure of the stabilizing material.

### BRIEF DESCRIPTION OF THE DRAWINGS

FIG. 1 is a perspective view of an example concrete retaining wall block according to an embodiment of the invention, with internal and/or hidden details shown in dashed lines.

FIG. 2 is an example form for forming the concrete retaining wall block of FIG. 1.

FIG. 3 is an example two-part void form for use with the example form of FIG. 2.

FIG. 4 is an example base of the two-part void form of FIG. 3.

FIG. 5 is an example top of the two-part void form of FIG. 3.

FIG. 6 is a cross-section of the example concrete retaining wall block of FIG. 1, including a geogrid material in the void.

### DETAILED DESCRIPTION

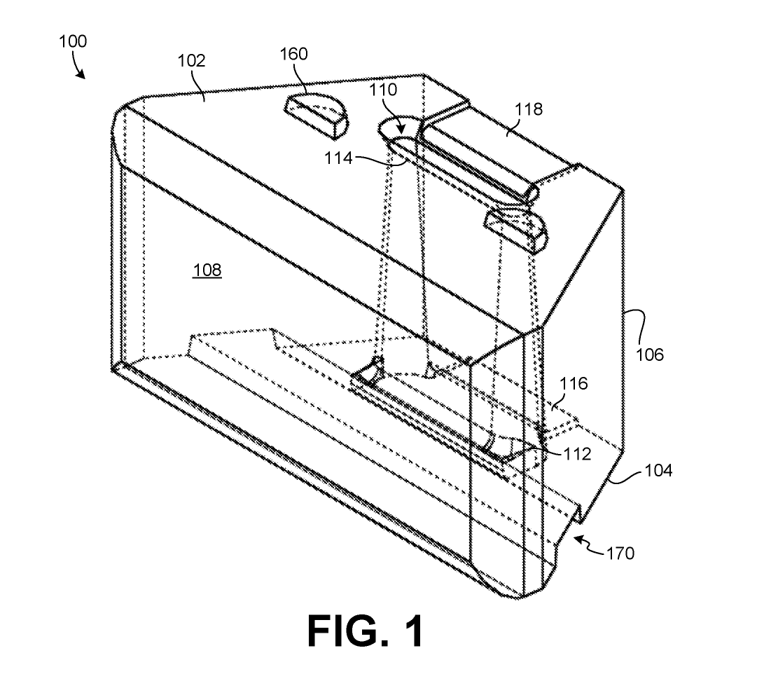

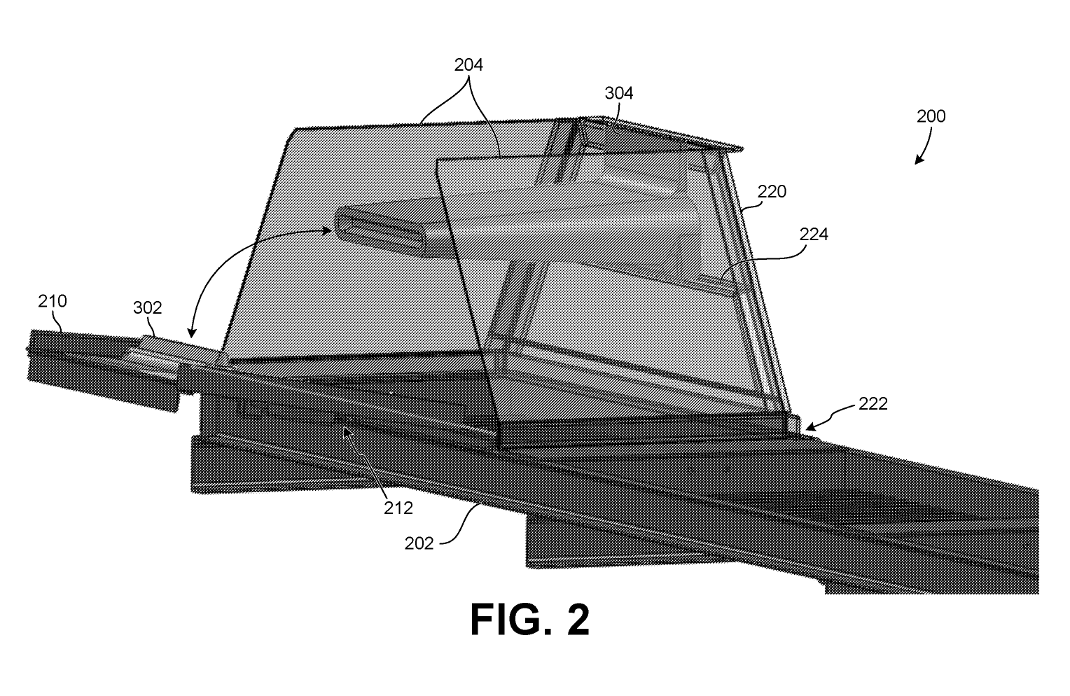

FIG. 1 illustrates an example concrete retaining wall block 100, according to an embodiment of the invention. The retaining wall block 100 includes a front face 108, which is the surface that is visible when the block is placed in a retaining wall. The configuration or profile of the front face 108 may be created by a liner pan placed in the block form (see FIG. 2) when the block is manufactured and may include indentations, protrusions, and/or other design markings. The front face 108 may also be colored as desired, for example with paint or stain. The purpose of the front face is to provide an aesthetically pleasing appearance. The block 100 may be symmetrical about a centerline running through the front face 108 and a back face 106.

The retaining wall block 100 also includes a top face 102 and a substantially parallel bottom face 104. The top face 102 is the face facing up when the retaining wall block 100 is positioned in a retaining wall. The bottom face 104 is the face facing down when the retaining wall block 100 is positioned in a retaining wall. The top face 102, as shown in FIG. 1, is configured to engage the bottom face 104 of an overlying block, as described in detail below.

The retaining wall block 100 also includes a back face 106 opposite to and approximately parallel with the front face 108. The back face 106 faces the retained material, the material behind the retaining wall.

The retaining wall block 100, as shown in FIG. 1, can also include two partial frustum-shaped conical knobs 160 protruding from the top face 102 of the block 100. The knobs 160 may be symmetrically spaced relative to the centerline of the block 100 and spaced substantially the same distance from the front face 108. The full block 100 can also include a transverse channel 170 in the bottom face of the block. The knobs 160 are configured to fit within the transverse channel 170 of an overlying block and such overlying block might be a full block, half block, top block or corner block. The highest protruding extent of a knob 160 may be less than the depth of the transverse channel 170 in an overlying block. The transverse channel 170 extends parallel to the front face 108 and can be spaced closer to the front face 108 than the knobs 160. In this way, an overlying block may be placed onto a lower block with the knob 160 of the lower block positioned within the transverse channel 170 of the upper block. The alignment of the conical knobs 160 in relation to the first transverse channel 170 on an overlying block creates a natural internal batter when the blocks are stacked, and sets back the overlying block rearwardly of the lower block. In this way, the retaining wall built by stacking the blocks 100 will have a slant.

In order to move and maneuver the retaining wall blocks 100, a lifting loop, not shown, may be incorporated into the top face 102. The lifting loop can be latched onto for lifting the block 100. The loop can be positioned close to the centerline and includes a material of sufficient strength to support the weight of the block 100. Thus, the loop may comprise iron or steel. For instance, the loop may comprise galvanized steel. The loop may be coated with a plastic material to prevent corrosion.

The retaining wall block 100, according to some embodiments of the invention is a wetcast block that can be used to build gravity walls and mechanically stabilized earth (MSE) wall systems. As an example, the block 100 may fit into a 2′×2′×4′ envelope. The example block 100 has about 8 sq. ft. of face area, weighs about 1,700 lbs., and requires a maximum 1.6 cubic ft. of concrete per square foot of face area. A face area ratio is defined as the ratio of the volume of concrete need to form a block divided by the face area of the block. Accordingly, the face area ratio of the block 100, according to some embodiments, is less than 2 feet. Conventional retaining wall blocks have a face area ratio of greater than 2 feet and may be 3.4 feet or higher.

The block 100, shown in FIG. 1, further features a passageway or void 110 that extends vertically through the block. The void 110 has a larger cross-section 112 at the base, bottom face 104, of the block 100, the cross-section tapering to a smaller cross-section 114 at the top, top face 102, of the block 100. In the example embodiment shown, the void 110 is substantially wedge shaped, flaring proximal to the top face 102. In alternative embodiments, the void 110 of the block 100 can have other profiles as desired.

A lower channel 116 extends from the bottom of void 110 to the lower rear, or back face 106, of the block 100. A similar, upper channel 118 extends from the top of void 110 to the upper rear, or back face 106, of the block 100.

A block form, according to an embodiment of the invention, for molding retaining wall blocks, such as the example blocks described above, will now be described. The block form described herein is not intended to be limited to forming the blocks 100 described above. Other shapes of blocks can be made by varying the shape of the block form described herein.

Referring to FIG. 2, a block form 200 in accordance with an embodiment of the invention includes a pair of spaced apart sides 204, two plate-like sections 210 and 220, and a generally planar base frame 202. The first section is a top section 210 and is discussed in detail below. The second section is a bottom section 220 and is also discussed in detail below. A base frame 202 supports the two sections and a formed liner pan. The two sections 210 and 220 and the liner pan, when closed and locked together, form an enclosure, or casting space, into which moldable concrete can be poured and allowed to solidify.

According to an embodiment of the invention, the block form 200 further includes top hinges 212 connecting the top section 210 to the base frame 202 and bottom hinges 222 connecting the bottom section 220 to the base frame 202. The top and bottom hinges 212, 222 allow a finished block to be easily removed from the block form 200. The top section 210 can be rotated back from the top face of a block, as shown in FIG. 2, as shown by the arrow indicating the direction of movement of the top section 210.

The block form 200 may also include fabricated partial conical frustums, to form knobs 160, welded to the outside of the top section 210. The inside conical area of the frustums may have no negative relief to enable easy stripping of a block from the block form 200.

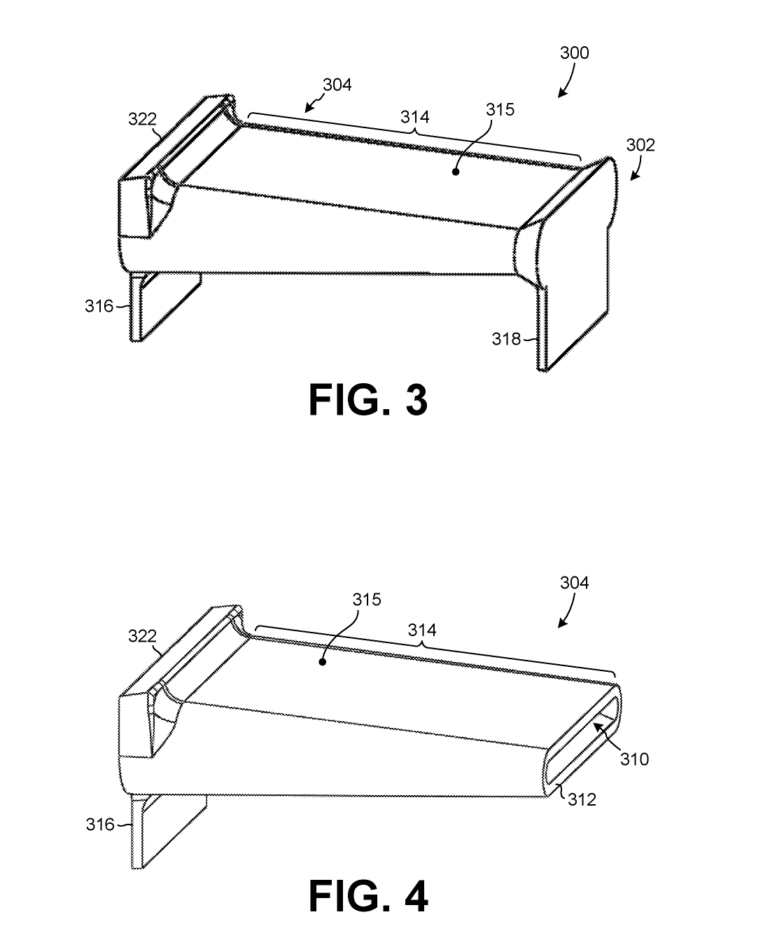

An insert 300, shown in FIG. 3, composed of two pieces 302 and 304, is inserted in the block form between the top section 210 and bottom section 220 of the block form 200, as shown in FIG. 2. The insert 300 forms the vertical void 110 in the block 100. The base 304 of the block form insert 300 forms the majority of the void through the block 100 and forms the lower channel 116 and the base opening 112. The top 302 of the block form insert 300 forms the upper channel 118 and the upper opening 114.

The base 304 of the block form insert 300, shown in FIG. 4, features a cavity 310 disposed at a top portion 312 of the base 304, a tapered portion 314 and protrusions 316 and 322. The cavity 310 assists with interfacing and aligning the base 304 with the top 302 of the block form insert 300. The base 304 features a tapered portion 314 that forms the majority of the void 110, extending through the block 100. A surface 315 of the tapered portion 314 forms a rear wall 120 of the void 110. Disposed at the bottom of the base 304 are protrusions 316 and 322. Protrusion 316 forms the lower channel 116 in the cast block 100. Protrusion 322 rests on a bottom ridge 224 of the bottom section 220 of the block 100 block form 200 and a first surface of the base 304 is against the bottom section 220. The bottom ridge 224 forms the transverse channel 170 of the cast block.

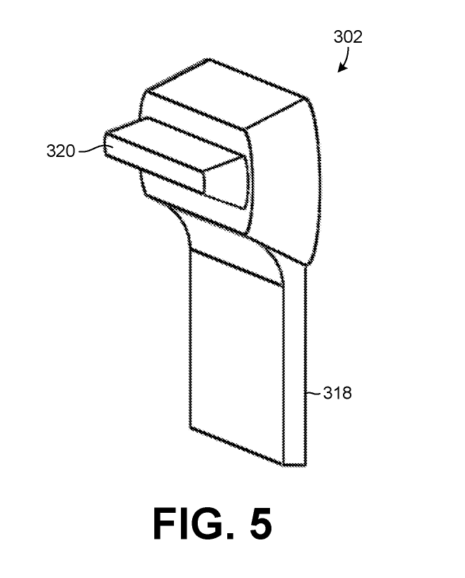

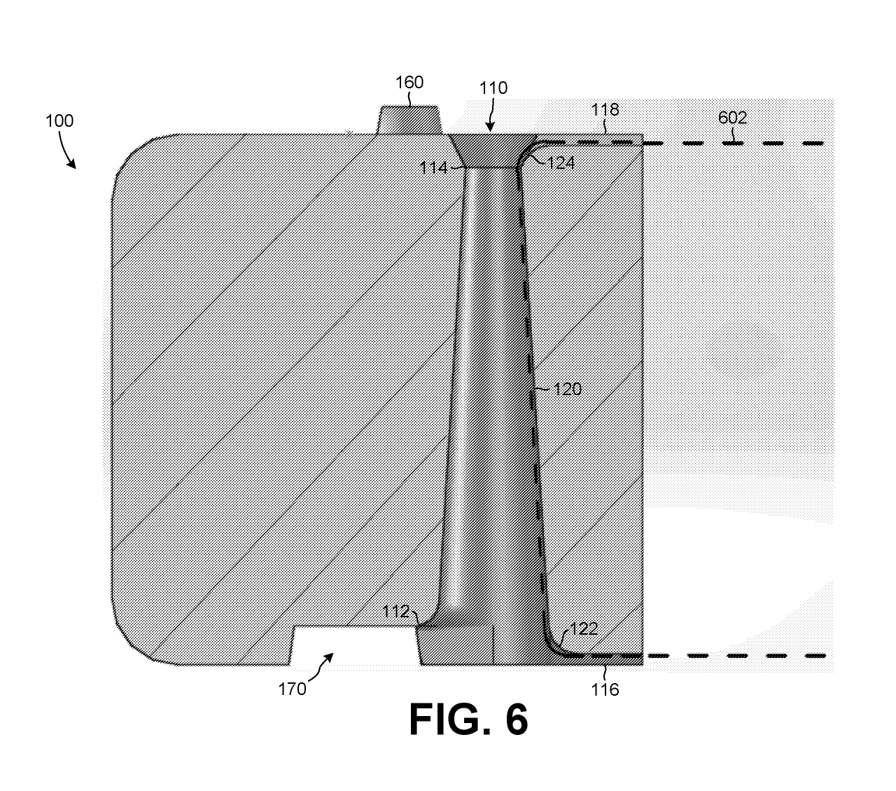

The top 302 of the block form insert 300, shown in FIG. 5, features transverse protrusions 318 and 320. The protrusion 318 forms the upper channel 118 in the block 100. The protrusion 320 interfaces with the cavity 310 on the base 304. The tapered nature of the protrusion 320 allows the protrusion to engage and then assist with aligning the top 302 and the base 304 of the block form insert 300. The top 302 is affixed to the top section 210 of the block form 200, with a first surface of the top 302 against the top section 210.

FIG. 2 shows the base 304 and the top 302 of the block form insert 300 positioned inside the block form 200. The protrusion 322 of the base 304 is shown resting on the bottom ridge of the bottom section 220 of the block form 200, positioning the block form insert 300 vertically within the block form 200. The protrusion 316 of the base 304 extends vertically along the bottom section of the block form, forming the bottom channel 116 in the cast block 100. The base 304 can be restrained in position against the bottom section 220 of the block form 200 by an adhesive or mechanical fastener. Alternatively, the closure and locking of the block form can exert a compressive force on the block form insert 300, thereby firmly clamping the two pieces 302, 304 of the insert 300 and restraining the block form insert 300 in position using a friction fit.

In the embodiment shown, the top 302 is affixed to the top section of the block form 210. The top section 210 of the block form is rotated upward, carrying the top 302, a second surface, the protrusion 320 of the top 302 engages a second surface, or cavity 310 of the base 304 that is contacting or affixed to the bottom section 220 of the block form 200.

Once the block form 200 is closed with the insert 300 secured within, concrete can be poured into the block form to cast the block 100 having the void 110. Once the concrete has cured to a desired level, the block 100 can be extracted from the block form 200. The top section 210 of the block form 200, with the top 302 affixed, is rotated downward, extracting the top 302 from the cast block 100 and separating the top 302 from the base 304. A piece of equipment that has a lifting system with an adequate lift capacity is connected to the lifting hook in the block. As the equipment lifts in the vertical plane, the block 100 and form base 220 pivot back and rotate along hinge points 222. The block separates from the bottom section 220 and the insert base 304. Alternatively, the base section 220 of the block form 200 is detached from the base 304, if necessary, and swung down away from the cast block 100. The base 304 can then be pulled from the cast block 100, leaving a completed concrete wall block 100 having a vertical void 110.

When arranged to form a wall, concrete blocks, such as the block 100 are anchored with a stabilizing material such as stabilizing sheets, straps or a geogrid material that extends from the block into the retained material. The weight of the retained material on the stabilizing material generates large amounts of friction that restrain the stabilizing material within the retained material, preventing the stabilizing material from detaching or slipping from the retained material. Since the block 100 is engaged with the stabilizing material, the block 100 is also restrained in position.

In the disclosed block designs, a stabilizing material 602, such as a geogrid, is wrapped through the void 110 of the block 100 as shown in FIG. 6. The stabilizing material 602 extends through the void 110, along rear wall 120 of the void 110. At the base of the block 100, the stabilizing material 602 wraps around radius 122 of the void 110 and extends from the block 100 through the channel 116 out into the retained material. At the top of the block, the stabilizing material 602 wraps over radius 124 and extends from the block 100 through channel 118 out into the retained material. The internal surface of the void, including rear wall 120, the radii 122 and 124 and the channels 116 and 118 can be considered contact surfaces for the stabilizing material 602, that is, these are potential surfaces that the stabilizing material 602 can contact when engaged with the block 100.

In engaging the block 100 and the stabilizing material 602 in this way, the likelihood of the engagement failing is minimal since the body of the block 100 anchors the stabilizing material. The force of the engagement of the stabilizing material 602 and the block 100 is dispersed across various contact surfaces, such as an internal face of the void, including a rear wall 120, the radii 122 and 124 and the channels 116 and 118, that contact or engage the stabilizing material 602. The strength of the system is more dependent on the strength of the stabilizing material 602 itself in this design since the likelihood of the concrete block 100 failing is minimal in relation to the strength of the stabilizing material 602.

As the retaining material is loaded on the stabilizing material, the stabilizing material 602 can move within the void 110, channels 116 and 118 and over the radii 122 and 124, of the block 100. Movement of the stabilizing material 602 against the contact surfaces and features of the block 100 can cause abrasion of the stabilizing material 602. Further, once the retaining wall is in place, settling and shifting of the retaining material can also cause movement of the stabilizing material 602 against the block 100 or portions thereof, causing abrasion. The abrasion in both examples can be exacerbated due to the loading and stretching of the stabilizing material 602 under tension when it is in place within the retaining material. With the stabilizing material 602 under tension due to the retaining material thereon, the friction between the block 100 and the stabilizing material 602 is increased due to the loading, which can cause increased abrasion of the stabilizing material 602.

In the disclosed embodiments, the abrasion of the stabilizing material 602 and the concrete block 100 is minimized by reducing the amount of friction between the concrete block 100 and the stabilizing material 602 at the contact surfaces of the block 100. The amount of friction between the stabilizing material 602 and the block 100 can be reduced by coating or covering the points of contact and/or contact surfaces of the block 100 in a low or reduced friction material. The points of contact or contact surfaces can include radii 122 and 124 of the void 110, the rear wall 120 of the void 110 and potentially other areas of the block 100 contacted by the stabilizing material 602. The low friction material reduces or minimizes the friction and abrasion between the block 100 and the stabilizing material 602, thus preserving the integrity and strength of the stabilizing material 602.

The low friction material creates a reduced friction surface against which the stabilizing material 602 is engaged and can slide or move relative too. The reduced friction of the surface reduces the abrasion of the stabilizing material 602 caused by movement of the material 602 relative to the block 100. The surface of the case concrete block 100 has an initial coefficient of friction that is dependent on the casting method and concrete composition. The low friction material that is placed on or over contact surfaces of the concrete block 100 has a second, reduced, or lower, coefficient of friction that that of the cast concrete, the initial coefficient of friction. In alternative embodiments, the contact surface of the cast concrete block 100 can undergo surface treatments to lower or reduce the coefficient of friction of the contact surface.

A low friction material, such as a polymer, epoxy, resin, paint or other material or membrane can be applied to the desired portions of the block 100 after the block has been cast. The low friction material can be applied to the block by spraying or manually or automatically applying the material to the desired portions of the block 100. The coating process can be done at the block manufacturer or on-site at the location of the block installation.

The low friction material covers the areas and/or surfaces of the block 100 in contact with the stabilizing material 602, such as the rear wall 120 of the void 110, the radii 122 and 124, and channels 116 and 118. Covering the contact surface areas of the block 100 with the low friction material provides an interface separating the stabilizing material 602 from the concrete surfaces of the block 100, limiting the abrasion of the stabilizing material 602 against the block 100. Due to the contact between the stabilizing material 602 and the low friction material, the low friction material should be of suitable strength and hardness to withstand abrasion and loading caused by the stabilizing material 602.

In an embodiment, the low friction material can be a polymer coating that is applied over portions, such as the contact surfaces, of the block 100 and cures to a hard, smooth surface having a low coefficient of friction. The polymer coating can be a two-part epoxy or resin, which can be applied using a spray system, by hand, brush or other suitable means. The polymer coats the concrete surface of the block 100, filling and smoothing surface roughness. The polymer can also minimize sharp or rough, points or features along the surface of the concrete, such as those created during the manufacturing process. By minimizing sharp or rough, points or features, the polymer prevents those areas from engaging with and potentially weakening the stabilizing material 602.

In a further embodiment, the low friction material can be an insert composed of a plastic, such as polytetrafluoroethylene (PTFE or Teflon®), a high density polyethylene or other plastic. The plastic insert has a smoother surface and a lower coefficient of friction than the concrete surface. The insert can be embedded in the block 100 during the casting process or affixed to the block post casting. The stabilizing material 602 will engage the insert rather than the concrete, minimizing abrasion and/or wear of the stabilizing material 602.

The PTFE, or other durable, low-friction material, insert can be affixed to the block 100 with an adhesive, post-casting. Alternatively, the insert can be designed to be placed within the void 110 and “snapped” onto the block 100 to engage the block 100 and retain the insert in place. The press fit insert allows for ease of installation of the insert, which can be done at the manufacturer or on-site.

The low friction material used in conjunction with the block 100 and stabilizing material 602, is preferably one that will not break down in the conditions it is used. That is, the low friction material should not break down in the earthen environment the block 100 and stabilizing material 602 are used. In the examples above, the low friction materials are synthetic and unlikely to break down when used in a real world environment.

In another low-friction embodiment, the contact surfaces of the concrete block 100 can be polished where contacting the stabilizing material 602, such as geogrid material. Polishing the contact surfaces, 116, 118, 120, 122 and/or 124, reduces the abrasive quality of the concrete and reduces the friction between the stabilizing material 602 and the block 100. Additionally, polishing the surfaces of the block 100 does not require the application of a chemical, such as a coating, or the inclusion of another material, such as a PTFE insert. This reduces the potential of chemical leaching and environmental contamination, which can be an important consideration when installing a retaining wall in an environmentally sensitive area.

Testing has shown that a block and geogrid material system like that described above has improved geogrid material retainment using industry standard testing and procedures.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A concrete retaining wall block, comprising:
a front face;
a back face opposite the front face;
a bottom face;
a top face opposite the bottom face; and
a void disposed within the block and spanning vertically between the bottom face and the top face, the void including:
an internal face;
the void configured to receive a portion of stabilizing material, the stabilizing material engaging with at least a portion of the internal face at a contact surface.

2. The concrete retaining wall block of claim 1, wherein the top face includes a protrusion configured to interface with a recess in the bottom face of a second block, the interface of the protrusion and the recess configured to align the block with the second block.

3. The concrete retaining wall block of claim 1, wherein the contact surface of the internal face has a reduced coefficient of friction.

4. The concrete retaining wall block of claim 1, wherein the contact surface of the internal face is coated in at least one of a polymer, an epoxy, a resin and a paint, the coating configured to reduce the coefficient of friction of the contact surface of the internal face.

5. The concrete retaining wall block of claim 1, wherein the contact surface of the internal face is polished.

6. The concrete retaining wall block of claim 1, wherein the contact surface of the internal face includes an insert formed of a material having a reduced coefficient of friction.

7. The concrete retaining wall block of claim 6, wherein the insert is formed of PTFE.

8. A concrete retaining wall block, comprising:
a front face;
a back face substantially parallel to the front face;
two side faces;
a bottom face, the bottom face including a first recess and a first channel, the first recess running parallel to the front face and spanning between the two side faces;
a top face substantially parallel to the bottom face, the top face including a second channel and two protrusions disposed substantially about a centerline of the block, the two protrusions configured to engage with the first recess of a second, overlying block; and
a void disposed within the block and spanning vertically between the bottom face and the top face, the void including:
a first end at the bottom face;
a second end at the top face; and
a rear wall extending between the first channel and the second channel;
the first channel extending along the bottom face of the block from the rear wall of the void to the back face of the block;
the second channel extending along the top face of the block from the rear wall of the void to the back face of the block;
the void configured to receive a length of stabilizing material, the stabilizing material engaging with at least one of the rear wall, the first channel and the second channel;
the at least one of the rear wall, the first channel and the second channel having a reduced friction surface, the reduced friction surface configured to minimize the amount of friction between the stabilizing material and the engaged rear wall, the first channel and the second channel.

9. The concrete block of claim 8, further including a first radius between the rear wall and the first channel and a second radius between the rear wall and the second channel, the first radius and the second radius having a reduced friction surface configured to engage the stabilizing material.

10. A concrete block form for casting a concrete block having a void, the concrete block form comprising:
a generally planar base frame;
a pair of spaced apart sides each connected along a first edge to the base frame to define a casting space;
a first plate section connected to the base frame by a first hinge transverse to the first edges, the first plate section configured to rotate about the first hinge into a closed position, wherein the first plate section contacts each of the pair of sides along a second edge of each side;
a second plate section connected to the base frame by a second hinge transverse to the first edges, the second plate section positioned opposite the first plate section and configured to rotate about the second hinge into a closed position, wherein the second plate section contacts each of the pair of sides along a third edge of each side; and
a block form insert comprising,
a top having a first surface configured to engage the first plate section and a second surface substantially opposite the first surface,
a bottom having a first surface configured to engage the second plate section and a second surface substantially opposite the first surface,
the second surface of the top engaging the second surface of the bottom when the first plate section and the second plate section are in the closed positions, and the block form insert spanning the casting space and forming a substantially wedge-shaped void in a concrete block cast in the concrete block form.
